(19) United States
(12) Patent Application Publication
(10) Pub. No.: US 2007/0143264 A1
(43) Pub. Date: Jun. 21, 2007

(54) Dynamic search interface

(75) Inventor: Christopher T. Szeto, Sunnyvale, CA (US)

Correspondence Address: BEYER WEAVER LLP, P.O. BOX 70250, OAKLAND, CA, 94612-0250, US

(73) Assignee: YAHOO! Inc.

(21) Appl. No.: 11/316,028

(22) Filed: Dec. 21, 2005

(51) Int. Cl. G06F 17/30

(52) U.S. Cl. 707/3

(57) ABSTRACT

A dynamic search interface presents a context which changes in response to user interaction. When the user engages the interface, it responds dynamically to display relevant information and controls. When the user disengages the interface, it returns to a simpler form.

### BACKGROUND OF THE INVENTION

The present invention relates to search interfaces and, more specifically, to search interfaces which dynamically present contextually relevant information.

Most interfaces for searching the Web are rendered in a Web page surrounded by information, much of it extraneous, which is largely static. For example, the current state of the art typically provides vertical search categories in association with a keyword text box. Selection of a particular vertical search category (e.g., Web, Images, News, etc.) focuses a subsequent search within that category.

The Web page in which the search box is embedded may also include a wide variety of information and links relating to other information and services provided by the Web page publisher. Much of this visual clutter in the user interface detracts from the goal of providing an intuitive and efficient search mechanism. There may even be additional search boxes each having a specific search focus, e.g., the particular Web site which includes the page. This can make it even more difficult for a user to determine how to proceed.

Many conventional search interfaces provide sophisticated refinements, e.g., shortcuts, to enable more efficient searching. However, the static nature of the information associated with such search interfaces is not well suited to educating the user about the availability of such refinements. It is not until a search is executed that such tools are typically made apparent to the user. Even recent refinements which respond as a user types in a search box do not address all of these issues.

In view of the foregoing, more intuitive and efficient search interfaces are desirable.

### SUMMARY OF THE INVENTION

According to the present invention, methods and apparatus are provided for facilitating a search. A search box is presented in a computing device interface. A plurality of vertical search categories are presented in association with the search box in response to activation of the search box. The vertical search categories are removed from the computing device interface in response to deactivation of the search box.

According to specific embodiments, first contextual information relating to a first one of the vertical search categories is also presented in response to activation of the search box. The first contextual information is replaced with second contextual information relating to a second one of the vertical search categories in response to selection of the second vertical search category.

According to a specific embodiment, a search is initiated within the first vertical search category in response to selection of a portion of the first contextual information. According to another embodiment a search scope within the first vertical search category is narrowed in response to selection of a portion of the first contextual information. According to yet another embodiment, access to a resource relating to the first vertical search category is facilitated in response to selection of a portion of the first contextual information. According to still another embodiment, additional contextual information within the first vertical search category is presented in response to selection of a portion of the first contextual information, the additional contextual information relating to the selected portion of the first contextual information.

According to some embodiments, the first and second contextual information may each include at least one of a link to a prior search in the corresponding vertical search category, a control operable to constrain a scope of a search within the corresponding vertical search category, a link to a resource relating to the corresponding vertical search category, and a link to additional contextual information within the corresponding vertical search category. According to some embodiments, the first and second contextual information may include at least one link which is operable to facilitate navigation of one of a menu, a file system, and a hierarchical data structure. According to some embodiments, the first and second contextual information may include a user interface operable to refine the search. According to some embodiments, the first and second contextual information may include advertising content relating to a current context.

A further understanding of the nature and advantages of the present invention may be realized by reference to the remaining portions of the specification and the drawings.

### BRIEF DESCRIPTION OF THE DRAWINGS

FIG. 1-7 are screen shots illustrating the operation of a dynamic search interface according to a specific embodiment of the invention.

FIG. 8 is an exemplary network diagram illustrating some of the platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention represent a new interaction concept in which a relatively simple, clean user interface is used initially to engage the user. When the user engages or “touches” the interface, it responds dynamically to display relevant pieces of information and controls. When the user disengages the interface, e.g., clicks elsewhere on the page, the interface returns to the simpler form.

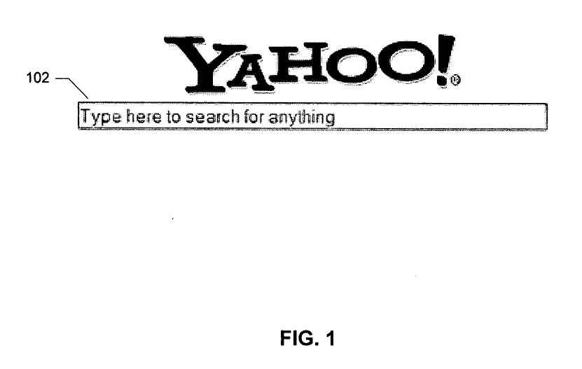

Embodiments of the present invention are intended to provide a single search interface which enables a user to search for virtually anything in a wide variety of contexts. According to a specific embodiment illustrated in FIG. 1, a single stripped down search interface is initially provided. The initial interface includes a search box 102 and very little else, e.g., the Yahoo! logo and the background text “Type here to search for anything” in the search box. This simplified representation, coupled with appropriate placement in the page in which it is embedded, is intended draw the user's attention to the available search mechanism without conveying the impression that the search interface has a limited focus.

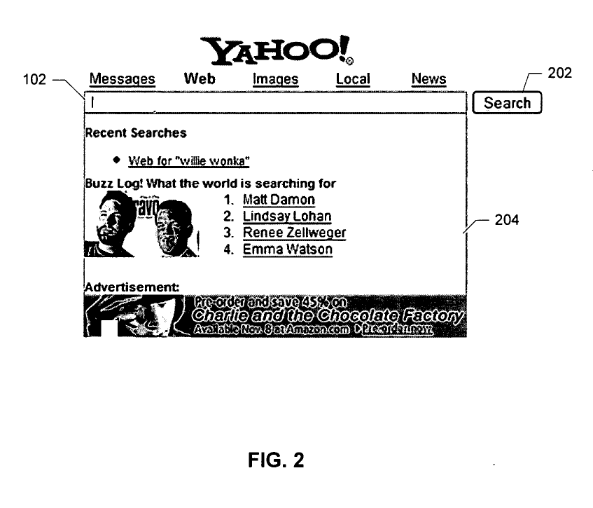

When the user activates a cursor in the search box (e.g., an “on focus event” effected with a mouse, the Tab key, or by beginning to type) or otherwise engages the search interface, the context of the search interface automatically changes. As shown in FIG. 2, a plurality of vertical search categories (e.g., Messages, Web, Images, Local, News) are presented in association with search box 102 which is now enabled for text entry. In the example shown, the Yahoo! logo has decreased in size, and a conventional “Search” button 202 has been provided with which searches may be initiated.

As described above, in response to the on-focus event and before the user begins typing in the search box, the search interface of the present invention is operable to dynamically display information or controls which are contextually relevant and/or which guide the user through the process of constructing an effective search. Such an approach is advantageous with respect to conventional, more static interface in that the dynamic nature of this interface serves to alert users to the available options. The advantage is particularly great relative to more cluttered interfaces in which even prominently displayed vertical search categories might be obscured.

It will be understood that the vertical search categories shown and the order and relative placement of the category links are merely exemplary. According to some embodiments, the categories may be customized either directly, e.g., as explicitly specified or selected by the user, or indirectly, in response to the user's behavior over time. If the user selects some other object on the page outside of the current components of the search interface, the search interface returns to its initial state (e.g., FIG. 1).

The vertical search categories may represent any search domain. They may include conventional categories which are in widespread use today, e.g., Web, Images, News, Shopping, Local, Languages, etc. They may also include categories which are more user specific. For example, as shown in FIG. 2, a Messages category may be presented in which the user can search his messages, e.g., emails, voice mails, instant messages, etc. Similarly, a Contacts category could be presented in which the user can search and manage an address book. Additional user-specific categories might enable the user to search his desktop, a private LAN or WAN on which the user's machine is operating, or a portion of a remote server controlled or operated by the user.

Vertical search categories could also represent specific domains of interest for the user. For example, an academic might have a vertical search category which represents publications relating to his academic specialty. Alternatively, a sports enthusiast might elect to have a Sports News category rather than the more general News category. Vertical search categories may also change over time to reflect, for example, identified user preferences, currently popular categories, new categories for promotion, etc. As will be understood with reference to these examples, the variations within the scope of the invention are virtually limitless.

Referring again to FIG. 2, a dynamic context box 204 may also be provided which includes a variety of information and/or links relating to the current search context (which may correspond to a selected one of the vertical search categories). As the search context changes (e.g., by user interaction with the interface), the information in the context box changes to reflect the new context. In the example shown in FIG. 2, the information in the context box may relate to the currently selected vertical search category. That is, when the vertical search categories are presented, one of them (e.g., Web) may be automatically selected. The selected category could be the first one in the list, or a category selected by the user in a previous search. In either case, the context box is simultaneously presented with the search box and includes contextual information relating to the selected category. Alternatively, the context box may not appear until the user takes some further action beyond activation of the cursor, e.g., selection of one of the categories, or typing in the search box.

The information in the context box may relate to the selected vertical search category and/or the current context in a wide variety of ways. As shown in FIG. 2, recent searches conducted by the user may be identified, selection of which will cause the same search to be performed. Currently popular searches relating to the selected category may also be provided. In the example shown, a recent search conducted by the user in the Web vertical search category is listed in the context box along with 4 currently popular Web searches in the “Buzz Log.” As shown, contextually appropriate advertising content may also be included. Selection of any of the information provided in context box 204 begins the corresponding search. Thus, a search may be initiated without the user having to enter a single character in the search box.

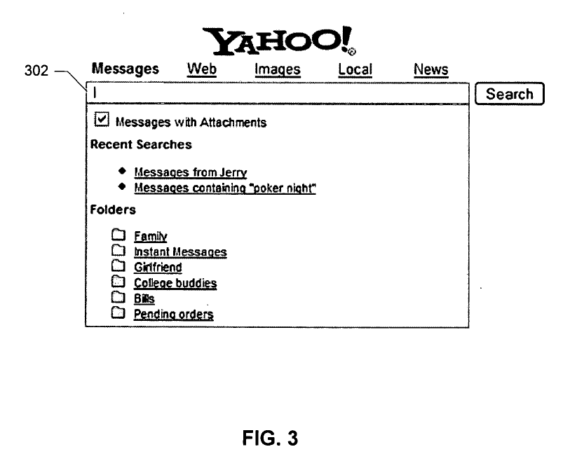

As mentioned above, the information in the context box dynamically responds to changes in the search context. Thus, for example, if the user selects the Messages vertical search category, the information in context box 204 is updated to reflect the new context as shown in FIG. 3. In this example, folders in which the user stores messages, e.g., instant messages, voice mails, emails, etc., (which may be locally or remotely stored) are represented in context box 204. Selection of a specific folder (or subfolder within a folder) changes the search context to enable the user to search within the selected folder.

Selection of a Contacts category might result in a context in which the context box shows folders, lists, or categories of contacts which can be scrolled through or navigated within the context box. Selection of a specific contact would then result in presentation of the corresponding contact information either in the context box or some other window. According to specific embodiments of the invention, when the specific contact information is presented, the user may be provided with the ability to edit the information inline, i.e., in the current context, without having to launch some other application. Another example could be in the Messages context which allows the user to edit his online status for Instant Messaging purposes. As will be appreciated, this feature is applicable to any context in which the user has such editing authority or capability.

Selection of a Languages vertical search category could result in a list of common languages in the context box which can be employed to further refine the search. Selection of a particular language might result in a list of dialects in the context box, and so on.

For any given search context or domain, e.g., a specific message folder, the context box might also include more advanced search refinements. For example, in the context of the Messages vertical search category, the context box may include one or more options with check boxes (e.g., check box 302 of FIG. 3) with which the scope of a search may be constrained. Such options might limit the search, for example, to messages with attachments, messages having the search term in the title, messages having embedded or attached images, messages corresponding to a specific time period, etc. Again, with this approach, a search may be refined even before the user begins typing anything into the search box.

In addition to introducing efficiency by allowing the scope of the search to be refined in advance, embodiments of the present invention also promote awareness in the user to the availability of such refinement tools earlier than conventional approaches. And from a more global perspective, enabling users to focus and refine searches prior to execution will likely have the desirable effect of reducing network traffic.

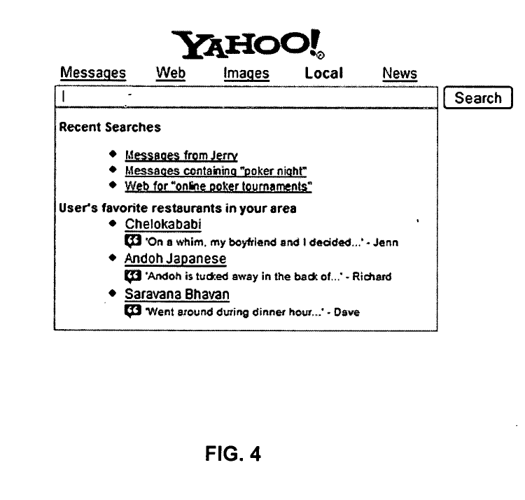

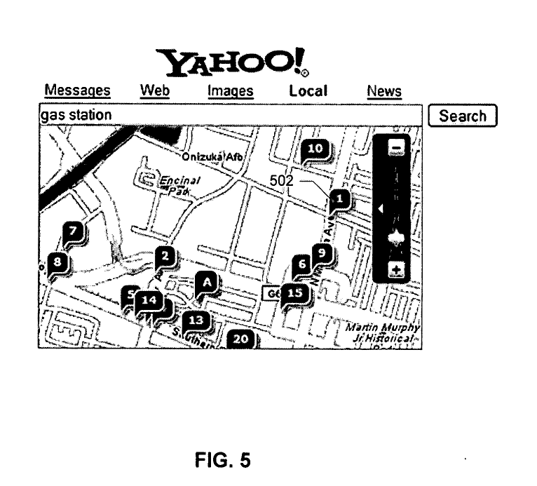

The range of options which might be presented in the context box or equivalent mechanism varies considerably with the specific context. Other options which might be presented include, for example, searches or links relating to a user's profile or preferences which have been determined either with direct user input, or by analysis of the user's online behavior. Geographically specific information, e.g., the user's favorite local restaurants, might be presented in the context of a Local vertical search category based on the user's location (see FIG. 4). According to a specific embodiment shown in FIG. 5, a map is loaded into the context box which corresponds to the user's location (e.g., as determined with reference to the user's zip code). Searches within the depicted geographic region could be performed as the user types with search results being identified on the map with icons 502. The user could also interact with the map to manipulate the geographic area (and thus refine the scope of the search), or even to jump to a specific destination on the map.

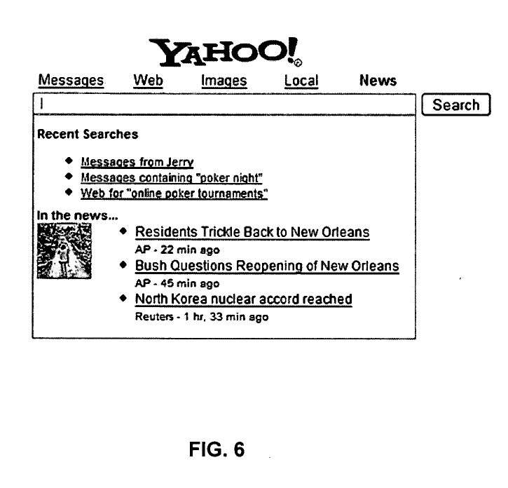

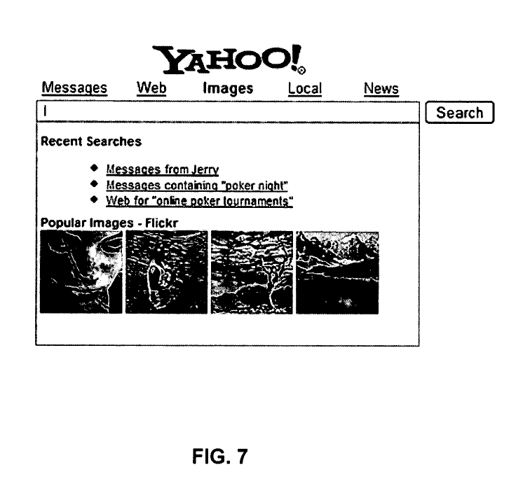

The context box may include current headlines and/or image thumbnails (potentially from the user's favorite news sites, publications, or RSS feed subscriptions) in the context of a News vertical search category (see FIG. 6). Image thumbnails (e.g., from Flickr) might be included in the context of an Images vertical search category (see FIG. 7). Commercially sponsored links or searches may also be included within any context which are selected based on the context.

The context box may also include socially networked information relevant to the user's friends or social network. For example, for a Local search, the context box might include recent (i.e., time relevant) reviews of restaurants in the user's geographic area (i.e., user relevant) made by the user's friends (i.e., socially relevant).

As emphasized above, embodiments of the invention enable a user to focus, refine, and even initiate a search before typing anything into the interface. According to some embodiments, dynamic characteristics of the search interface may also be responsive to user typing and/or specific keywords entered in a search box. For example, the context box may dynamically change to include a user's past searches which correspond to the text string being entered in the search box. Additionally, the context box may include information or search options which are responsive to a particular keyword or anticipated keyword (i.e., before the keyword is completely typed). For example, if the user types “SF Gi,” recent searches by others on the Web relating to the San Francisco Giants or Major League Baseball might be identified in the context box. In another example, a stock quote could be included in the context box in response to the four-letter company abbreviation (e.g., YAHOO) in the search box. In yet another example, images corresponding to a keyword in the search box could be dynamically presented (e.g., as thumbnails) in the context box as the user types. In still another example, in response to the keyword “contacts,” the context box could then be used to search for particular contact information in the user's address book as described above.

As noted above, the context box may include controls which enable a wide variety of functionality. One example of such a control is the check box for refining searches in the Messages context as described above with reference to FIG. 3. Additional examples include radio controls to select between various options, or any form control such as a drop down list box, buttons, sliders, or text boxes. Applets or applications may also be embedded in the context area, e.g., the local search example described above is an example of a Flash application embedded in the context area.

In addition, selection of an option within the context box may cause a number of different results. For example, as described above, a search might be initiated. Or, where the option corresponds to a specific URL, navigation to that URL occurs. As yet another example, selection of such options might result in a “drilling down” within the current context (e.g., a refinement of the search scope), in which case, the contents of the context box may change to reflect the new context. Moreover, because the context box instantly appears with appropriate contextual information which may be customized by the user, it may be used simply to monitor relevant information without typing. For example, by clicking in the search box and selecting the News vertical search category, the context box may be configured to present the latest news updates without even requiring the user to conduct a search.

It will be understood that the types of information, the manner in which the information and search context are presented, and the manner in which changes to the information and the search context are effected may vary considerably without departing from the scope of the invention. For example, the dynamic search interface of the present invention may be provided in a general Web search page or in a browser toolbar to enable searching of the Web, or the home page of a Web site or portal to enable searching of that site or portal. It may also be integrated into a messaging application to enable searching of a user's messages, or a desktop operating system to enable searching of a user device. More generally, any computing context in which a search capability is desirable may employ embodiments of the present invention. And, in any of the contexts in which a dynamic search interface designed according to the invention is deployed, it may be employed to enable searching beyond its primary context to any context within “reach” of the device.

Similarly, the information which is presented in response to the user putting focus on the search box is not limited to vertical search categories and/or the context box described above. Other contextual information might include, for example, advertisements which related to the current context. For example, the context box associated with a Movie Search might include the latest advertisement for a movie opening this Friday.

In addition, the contextual information presented in the search interface context and/or in the context box may be presented in ways other than those described above and shown in the figures. For example, the locations of the vertical search categories and the context box relative to the search box are not limited to the configurations depicted. The manner in which changes in the overall search interface context or the information in context box are effected may also vary considerably. According to a specific embodiment, as the user tabs through the vertical search categories, the information in the context box appears to slide right or left (depending on the direction of the tabbing) to reflect the context of the currently selected category. This navigation may also be effected using, for example, right and left arrow keys within the context box itself. According to another specific embodiment, when the user initially places the cursor in the search box, the screen appears to zoom in on the elements of the search interface such that they are the dominant objects on the screen. A wide variety of alternatives will be apparent to those of skill in the art.

In addition, embodiments of the invention are contemplated which enable a user to navigate within, for example, a menu or a file system. For example, as discussed above, the context box associated with a Messages vertical search category might include file icons which can be navigated in the context box in a manner similar to conventional navigation in a window on a desktop. Similarly, navigation through virtually any classification hierarchy could be facilitated within the context box to refine the scope of a search within a specific category or even to identify a specific document or resource. Navigation through the user's browser bookmarks may even be facilitated. That is, for example, one of the vertical search categories could be “Bookmarks,” selection of which could result in the user's familiar bookmarks interface (e.g., Yahoo!'s My Web) being presented in the context box for navigation and selection.

Navigation within the context box may be effected using a mouse, a keyboard (e.g., up, down, left, right, page up, and page down keys), or any other suitable I/O device. In addition, items in the context box could have associated functionalities (e.g., drop-down or pop-up menus), interaction with which may shift the context within the hierarchy being navigated.

And as will be appreciated, the various functionalities described herein may be implemented in a wide variety of ways without departing from the scope of the invention. For example, a specific embodiment of the invention for facilitating searching from a Web page is embedded in the page html (e.g., in Javascript). However, depending on the computing context and the particular application, a wide variety of other commercially available or proprietary software tools may be employed. For example, the search interface may be implemented as a stand-alone widget, as a desktop application or plug-in, or integrated with a desktop application (e.g., in a toolbar). In addition, the computer program instructions with which embodiments of the invention are implemented may be stored in any type of computer-readable media, and may be executed according to a variety of computing models including a client/server model, on a stand-alone computing device, or according to a distributed computing models in which various of the functionalities described herein may be effected or employed at different locations.

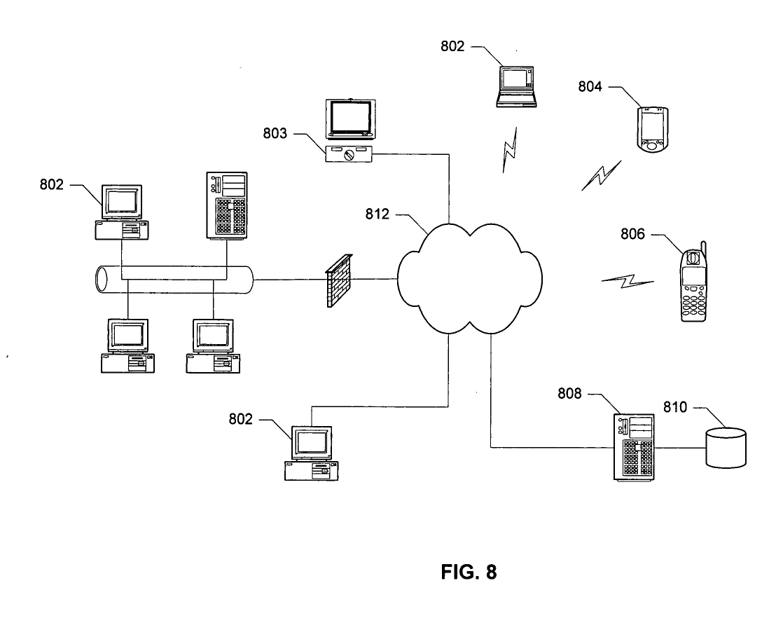

It should also be noted that the present invention may be implemented on any computing platform and in any network topology in which search is a useful functionality. For example and as illustrated in FIG. 8, implementations are contemplated in which the dynamic search interfaces described herein are employed on personal computers 802, media computing platforms 803 (e.g., cable and satellite set top boxes with navigation and recording capabilities (e.g., Tivo)), handheld computing devices (e.g., PDAs) 804, cell phones 806, or any other type of portable communication platform. As discussed above, such search interfaces may be resident on such devices, e.g., as part of a browser or other application, or be served up from a remote site, e.g., in a Web page, (represented by server 808 and data store 810). The invention may also be practiced in a wide variety of network environments (represented by network 812), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. For example, specific embodiments have been described herein with reference to a context box in which contextual information relating to the search context is presented. However, it will be understood that such contextual information may be provided in a wide variety of ways such as, for example, in a list near the search box, or even within the search box itself.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for facilitating a search, comprising:
presenting a search box in a computing device interface;
presenting a plurality of vertical search categories in association with the search box in response to activation of the search box; and
removing the vertical search categories from the computing device interface in response to deactivation of the search box.

2. The method of claim 1 further comprising:
presenting first contextual information relating to a first one of the vertical search categories in response to activation of the search box; and
replacing the first contextual information with second contextual information relating to a second one of the vertical search categories in response to selection of the second vertical search category.

3. The method of claim 2 further comprising initiating a search within the first vertical search category in response to selection of a portion of the first contextual information.

4. The method of claim 3 wherein the search is characterized by a search scope which includes at least one of a computing device with which the computing device interface is associated, the World Wide Web, a Web site, the Internet, at least one remote device, a local area network, and a wide area network.

5. The method of claim 2 further comprising narrowing a search scope within the first vertical search category in response to selection of a portion of the first contextual information.

6. The method of claim 2 further comprising facilitating access to a resource relating to the first vertical search category in response to selection of a portion of the first contextual information.

7. The method of claim 2 further comprising presenting additional contextual information within the first vertical search category in response to selection of a portion of the first contextual information, the additional contextual information relating to the selected portion of the first contextual information.

8. The method of claim 2 wherein the first and second contextual information each include at least one of a link to a prior search in the corresponding vertical search category, a control operable to constrain a scope of a search within the corresponding vertical search category, a link to a resource relating to the corresponding vertical search category, and a link to additional contextual information within the corresponding vertical search category.

9. The method of claim 2 wherein at least one of the first and second contextual information includes at least one link which is operable to facilitate navigation of one of a menu, a file system, and a hierarchical data structure.

10. The method of claim 2 wherein at least one of the first and second contextual information includes advertising content relating to a current context.

11. The method of claim 2 wherein at least one of the first and second contextual information includes a user interface operable to refine the search.

12. The method of claim 11 wherein the user interface includes at least one of a form control, a Java application, an embedded application, an ActiveX control, and a Flash application.

13. A computing device operable to perform the method of claim 1.

14. A computer-implemented method for facilitating a search, comprising:
transmitting computer program instructions to a computing device, the computer program instructions being operable to cause the computing device to present a search box in a computing device interface associated with the computing device, present a plurality of vertical search categories in association with the search box and first contextual information relating to a first one of the vertical search categories in response to activation of the search box, and replace the first contextual information with second contextual information relating to a second one of the vertical search categories in response to selection of the second vertical search category; and
transmitting at least a portion of the first and second contextual information to the computing device.

15. The method of claim 14 wherein the computer program instructions are further operable to initiate a search within the first vertical search category in response to selection of a portion of the first contextual information.

16. The method of claim 15 wherein the search is characterized by a search scope which includes at least one of the computing device, the World Wide Web, a Web site, the Internet, at least one remote device, a local area network, and a wide area network.

17. The method of claim 14 wherein the computer program instructions are further operable to narrow a search scope within the first vertical search category in response to selection of a portion of the first contextual information.

18. The method of claim 14 wherein the computer program instructions are further operable to facilitate access to a resource relating to the first vertical search category in response to selection of a portion of the first contextual information.

19. The method of claim 14 wherein the computer program instructions are further operable to present additional contextual information within the first vertical search category in response to selection of a portion of the first contextual information, the additional contextual information relating to the selected portion of the first contextual information.

20. The method of claim 14 wherein the first and second contextual information each include at least one of a link to a prior search in the corresponding vertical search category, a control operable to constrain a scope of a search within the corresponding vertical search category, a link to a resource relating to the corresponding vertical search category, and a link to additional contextual information within the corresponding vertical search category.

21. The method of claim 14 wherein at least one of the first and second contextual information includes at least one link which is operable to facilitate navigation of one of a menu, a file system, and a hierarchical data structure.

22. The method of claim 14 wherein at least one of the first and second contextual information includes advertising content relating to a current context.

23. The method of claim 14 wherein at least one of the first and second contextual information includes a user interface operable to refine the search.

24. The method of claim 23 wherein the user interface includes at least one of a form control, a Java application, an embedded application, an ActiveX control, and a Flash application.

25. At least one computing device operable to perform the method of claim 14.

26. A computer program product for facilitating a search, comprising at least one computer-readable medium having computer program instructions stored therein which are operable to cause a computing device to:
present a search box in a computing device interface;
present a plurality of vertical search categories in association with the search box in response to activation of the search box; and
remove the vertical search categories from the computing device interface in response to deactivation of the search box.

27. The computer program product of claim 26 wherein the computer program instructions are further operable to cause the computing device to:
present first contextual information relating to a first one of the vertical search categories in response to activation of the search box; and
replace the first contextual information with second contextual information relating to a second one of the vertical search categories in response to selection of the second vertical search category.

28. The computer program product of claim 27 wherein the computer program instructions are further operable to cause the computing device to initiate a search within the first vertical search category in response to selection of a portion of the first contextual information.

29. The computer program product of claim 28 wherein the search is characterized by a search scope which includes at least one of the computing device, the World Wide Web, a Web site, the Internet, at least one remote device, a local area network, and a wide area network.

30. The computer program product of claim 27 wherein the computer program instructions are further operable to cause the computing device to narrow a search scope within the first vertical search category in response to selection of a portion of the first contextual information.

31. The computer program product of claim 27 wherein the computer program instructions are further operable to cause the computing device to facilitate access to a resource relating to the first vertical search category in response to selection of a portion of the first contextual information.

32. The computer program product of claim 27 wherein the computer program instructions are further operable to cause the computing device to present additional contextual information within the first vertical search category in response to selection of a portion of the first contextual information, the additional contextual information relating to the selected portion of the first contextual information.

33. The computer program product of claim 27 wherein the first and second contextual information each include at least one of a link to a prior search in the corresponding vertical search category, a control operable to constrain a scope of a search within the corresponding vertical search category, a link to a resource relating to the corresponding vertical search category, and a link to additional contextual information within the corresponding vertical search category.

34. The computer program product of claim 27 wherein at least one of the first and second contextual information includes at least one link which is operable to facilitate navigation of one of a menu, a file system, and a hierarchical data structure, and wherein the computer program instructions are further operable to cause the computing device to facilitate the navigation using the at least one link.

35. The computer program product of claim 27 wherein at least one of the first and second contextual information includes advertising content relating to a current context.

36. The computer program product of claim 27 wherein at least one of the first and second contextual information includes a user interface operable to refine the search.

37. The computer program product of claim 36 wherein the user interface includes at least one of a form control, a Java application, an embedded application, an ActiveX control, and a Flash application.
